(19) United States
(12) Patent Application Publication
(10) Pub. No.: US 2022/0027785 A1
(43) Pub. Date: Jan. 27, 2022

(54) METHOD AND SYSTEM FOR OPTIMIZING WAITING TIME ESTIMATION BASED ON PARTY SIZE IN A RESTAURANT

(71) Applicant: Ricky Cheng, Orlando, FL (US)

(72) Inventor: Ricky Cheng, Orlando, FL (US)

(21) Appl. No.: 16/939,636

(22) Filed: Jul. 27, 2020

(51) Int. Cl. G06N 20/00; G06Q 50/12

(52) U.S. Cl. CPC G06N 20/00; G06Q 50/12

(57) ABSTRACT

Methods, systems, and apparatus, including computer programs encoded on computer storage media, for estimating waiting time are provided. One embodiment of the methods includes: collecting sensor data from a plurality of proximity sensors installed on a table and a plurality of weight sensors installed on a plurality of chairs electronically associated with the table; determining dining information of a dining party; training a classifier; obtaining a list of waiting parties requesting to dine in the restaurant, the list of waiting parties corresponding to a list of requested party sizes; standardizing the list of requested party sizes into a list of standardized party sizes; grouping the list of waiting parties into sublists based on the list of standardized party sizes; determining an estimated waiting time for each of the waiting parties in each sublist.

### TECHNICAL FIELD

The disclosure relates generally to systems and methods for optimizing waiting time estimation, in particular for optimizing waiting time estimation for dining parties based on party sizes and other information.

### BACKGROUND

Popular restaurants often need to estimate waiting times for customers. Inaccurate estimations are often a major source of customer dissatisfaction. Conventional methods to estimate waiting times may include manual estimation and individual-customer-level estimation.

The manual estimation methods may require restaurant employees to make rough estimations based on personal experiences, which are often inaccurate and may result in negative effects. For example, over-conservative estimations may discourage customers from waiting, and over-aggressive estimations may cause complaints and loss of credibility.

The individual-customer-level estimation methods usually measure the stay duration of each individual customer in the restaurant (e.g., including dining time and waiting time) by, for example, utilizing the real-time location information provided by customers' mobile devices, and provide estimations for waiting customers based on the average stay durations of the customers who have been served. However, the individual-customer-level estimation methods often fail to consider critical factors such as party sizes that may affect dining durations and/or waiting times for the parties of various sizes. Lastly, the fact that one party may be served by tables of different sizes drastically complicates the task to provide accurate waiting time estimations for the incoming dining parties.

### SUMMARY

Various embodiments of the present specification may include systems, methods, and non-transitory computer readable media for optimizing waiting times.

According to one aspect, a method for optimizing waiting times may comprise: collecting training data by repeating following steps for a predetermined number of times: receiving, by a computing device, sensor data from a plurality of proximity sensors installed on a table and a plurality of weight sensors installed on a plurality of chairs electronically associated with the table; collecting, by the computing device based on the sensor data, dining information of a dining party, wherein the dining information comprise: a first timestamp corresponding to a point in time when a first proximity sensor and a first weight sensor detect a first person of the dining party takes a seat at the table, a second timestamp corresponding to a point in time when a second proximity sensors and a second weight sensor detects a second person of the dining party leaves the table, a dining duration determined based on the first timestamp and the second timestamp, and a maximum number of persons simultaneously seated at the table between the first timestamp and the second timestamp; and after repeating the steps, training a classifier based on the training data, wherein the classifier is trained to generate an estimated dining duration in response to input data comprising a party size and an estimated starting time; obtaining, by the computing device through a terminal, a list of waiting parties requesting to dine in the restaurant, the list of waiting parties corresponding to a list of requested party sizes; standardizing, by the computing device, the list of requested party sizes based on available table sizes in the restaurant into a list of standardized party sizes; grouping, by the computing device, the list of waiting parties into sublists based on the list of standardized party sizes, each sublist corresponding to one of the available table sizes; determining, by the computing device, an estimated waiting time for each of the waiting parties in each sublist using the classifier and based on a position of the each waiting party in the each sublist; and for each of the waiting parties, dynamically updating the estimated waiting time, and sending a notification when a difference between an originally estimated waiting time and the updated estimated waiting time is greater than a predetermined threshold.

According to another aspect, a system for optimizing waiting times may comprise a computer system comprising a processor and a non-transitory computer-readable storage medium storing instructions executable by the processor to cause the computer system to perform operations comprising: collecting training data by repeating following steps for a predetermined number of times: receiving, by a computing device, sensor data from a plurality of proximity sensors installed on a table and a plurality of weight sensors installed on a plurality of chairs electronically associated with the table; collecting, based on the sensor data, dining information of a dining party, wherein the dining information comprise: a first timestamp corresponding to a point in time when a first proximity sensor and a first weight sensor detect a first person of the dining party takes a seat at the table, a second timestamp corresponding to a point in time when a second proximity sensors and a second weight sensor detects a second person of the dining party leaves the table, a dining duration determined based on the first timestamp and the second timestamp, and a maximum number of persons simultaneously seated at the table between the first timestamp and the second timestamp; and after repeating the steps, training a classifier based on the training data, wherein the classifier is trained to generate an estimated dining duration in response to input data comprising a party size and an estimated starting time; obtaining, through a terminal, a list of waiting parties requesting to dine in the restaurant, the list of waiting parties corresponding to a list of requested party sizes; standardizing, the list of requested party sizes based on available table sizes in the restaurant into a list of standardized party sizes; grouping, the list of waiting parties into sublists based on the list of standardized party sizes, each sublist corresponding to one of the available table sizes; determining, an estimated waiting time for each of the waiting parties in each sublist using the classifier and based on a position of the each waiting party in the each sublist; and for each of the waiting parties, dynamically updating the estimated waiting time, and sending a notification when a difference between an originally estimated waiting time and the updated estimated waiting time is greater than a predetermined threshold.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an example environment for optimizing waiting times in accordance with various embodiments;

FIG. 2 illustrates example sensor locations for optimizing waiting time estimation, in accordance with some embodiments.

FIG. 3 illustrates an example system for optimizing waiting time, in accordance with some embodiments.

FIG. 4 illustrates an example diagram for training a classifier, in accordance with some embodiments.

FIG. 5 illustrates an example diagram for standardizing and grouping dining requests, in accordance with some embodiments.

FIG. 6 illustrates an example flow for optimizing waiting time estimation, in accordance with some embodiments.

FIG. 7 illustrates an example method for optimizing waiting time estimation, in accordance with some embodiments;

FIG. 8 illustrates another example method for optimizing waiting time estimation, in accordance with some embodiments.

FIG. 9 illustrates an example electronic device for optimizing resource allocation.

### DETAILED DESCRIPTION

Embodiments of the described technology provide sensor-data-based methods and systems for providing estimated waiting times for parties of various sizes in a restaurant. Generally, waiting times for incoming parties are directly affected by dining durations of the current parties dining in the restaurant. There are various factors may affect the dining durations, such as starting time (e.g., what time of the day, which day of the week, and which month of the year), party size (e.g., parties of larger sizes will likely stay longer in a restaurant), available table sizes in the restaurant, another suitable factor, or any combination thereof. The impact of these factors on the dining durations may be learned from historical data. In some embodiments, when the learning process demands a high accuracy, fine-grained factors may be required (e.g., the starting time may be at minute-level). Also, multiple restaurants (e.g., a chain of local restaurants of the same franchise, or restaurants serving similar cuisine and within the same local community) may pool their historical data collected from a past period of time to provide sufficient training data to train a machine learning model. As a result, the amount of data to be learned from may easily reach to a point where manual approaches become impractical.

In order to accurately measure dining durations for parties, some embodiments may use sensors installed in a restaurant to track the parties' activities. For example, proximity sensors or other sensors detecting the presence of objects may be installed on or beneath the tables in the restaurant to detect that a party is being seated or a party is leaving. As another example, weight sensors installed on chairs may detect customers taking seats or leaving the chairs. The sensor data collected by these sensors may be used to determine accurate dining durations, which may not be readily obtained by existing estimation methods. For example, a restaurant may simply measure a dining duration based on a starting time and an ending time logged in its computer system, where the starting time is the point in time when the dining party makes the first order, and the ending time is the timestamp on the receipt. However, since the party may take some time to be fully seated, converse, read the menu, before making the first order, the party's actual starting time could be much earlier than the time of the first order. Similarly, it is not unusual for a party to stay and chat for a substantial period of time after making the payment and getting the receipt, and thus the timestamp on the receipt may not accurately reflect the actual ending time.

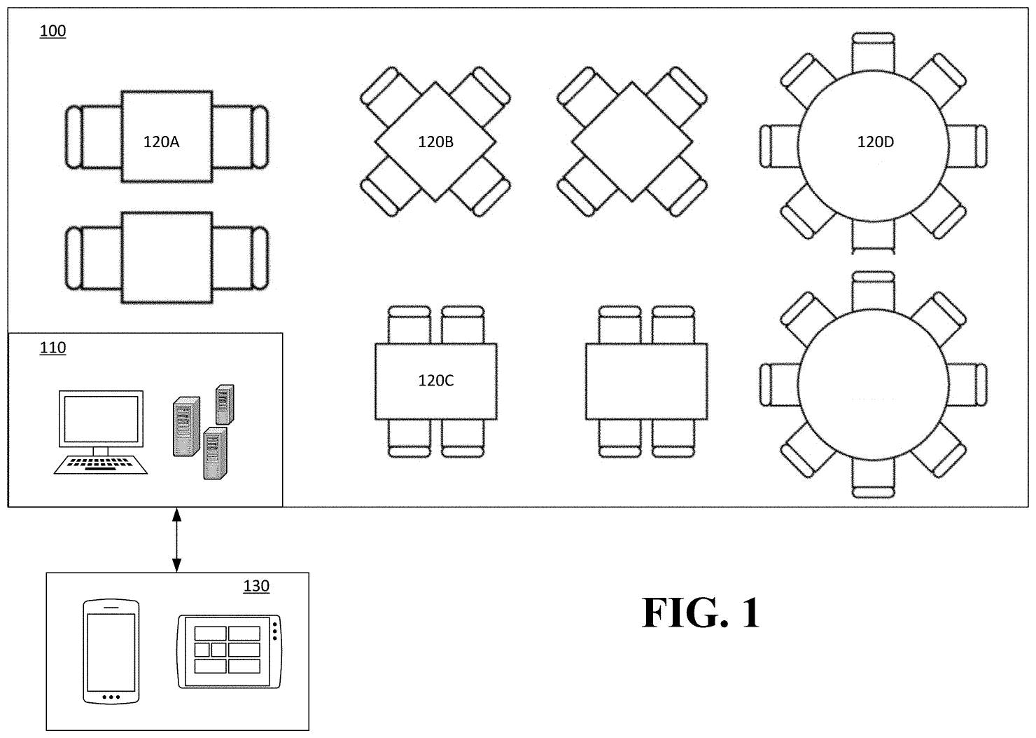

FIG. 1 illustrates an example environment for optimizing waiting time estimation in a restaurant may be applied, in accordance with various embodiments. As shown, the environment may comprise a plurality of dining tables in a restaurant 100, a computing system 110 associated with the restaurant 100, and computing devices 130 that users use to communicate with the computing system 110. The components of the system 100 presented below are intended to be illustrative. Depending on the implementation, the system 100 may include additional, fewer, or alternative components.

In some embodiments, the plurality of dining tables in the restaurant 100 may comprise tables of various serving capacities (e.g., sizes), such as tables 120A may serve up to 2 diners, tables 120B or 120C may serve up to 4 diners, and tables 120D may serve up to 8 diners. In some embodiments, a dining party may be served by one or more tables of different sizes. For instance, a table 120A may serve 1-2 diners and a table 120B may serve 2-4 diners, and thus a part of 2 may be served by either a table 120A or a table of 120B. In some embodiments, a dining party may only be served by tables of the same size. For instance, a table 120A may serve 1-2 diners and a table 120B may serve 3-4 diners, and thus a party of 2 may only be served by tables 120A, and a party of 4 may only be served by tables 120B.

In some embodiments, the computing system 110 associated with the restaurant 100 may be an on-premises computing system, a gateway device to cloud services, a terminal connected with remote servers. The computing system 110 may be implemented in one or more networks (e.g., enterprise networks), one or more endpoints, one or more servers (e.g., server), or one or more clouds. The server may include hardware or software which manages access to a centralized resource or service in a network. A cloud may include a cluster of servers and other devices which are distributed across a network. In some embodiments, the computing system 110 may also include a terminal to communicate with diners. For example, such terminal may be placed at the entrance of the restaurant 110 so that the dining parties may make dining requests through the terminal. As another example, such terminal may be a webpage or an application on a smartphone through which a dining party may fill in its information to make a dining request. The webpage or application may be configured to only allow users within a preset distance from the restaurant 100 to make dining requests (e.g., within 1 or 0.5 miles).

In some embodiments, the computing devices 130 that the users use to communicate with the computing system 110 may refer to user terminals, such as smartphones, smart pads, smart watches, other suitable smart devices, or any combination thereof. In some embodiments, a computing device 130 may collect its current (e.g., real-time) location.

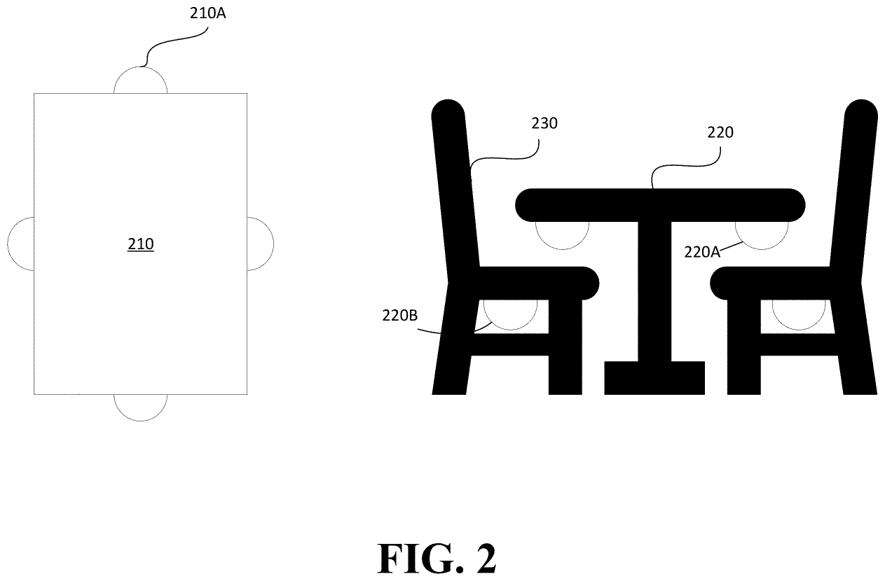

FIG. 2 illustrates example sensor locations for optimizing waiting time estimation, in accordance with some embodiments. One of the principles behind this specification is that various factors of a dining party may affect the dining party's dining duration, which may directly affect the waiting time estimation. Such factors may include the party's party size, the starting time (e.g., when the party is being seated), whether the party includes a child and if so, the child's age, another suitable factor, or any combination thereof. It is critical to automatically and accurately determine these factors in real-time. As mentioned previously, manually determining each party's information (e.g., the above-mentioned factors) by restaurant employees may be inaccurate and impractical (e.g., considering the high cost of labor, and the large volume of data). For example, a party size may dynamically change during the course of the dining (e.g., a new diner or someone who is late may join, or an existing diner may leave) and usually the employees may not notice such change, a starting time may not be accurately (e.g., at minute-level) recorded by manual means (e.g., the starting time is usually determined as the point in time of making the first order, which may be much later than the party's actual starting time, e.g., when the party is being seated), and similarly, an ending time may not be accurately determined (e.g., the ending time is usually determined as the time of checkout, which may be much earlier than the party's actual ending time). Furthermore, manually measuring the dining parties' size, starting time, ending time, etc. in a restaurant may limit the possibility of automatically sharing such data among multiple restaurants (e.g., similar restaurants in the local community).

In some embodiments, various sensors may be installed in the restaurant to automatically and accurately collect data of the dining parties. As shown in FIG. 2, a table 210 with a serving capacity of 4 may have four proximity sensors 210A installed on each side of the table. Each proximity sensor may send a signal when an object is detected within a preset distance. For example, a person who is taking a seat at the table 210 may be detected by one of the proximity sensors, and the seating time may be automatically registered to the computing system 110 of the restaurant 100.

In some embodiments, weight sensors may be installed on chairs to detect the presence of diners. As shown, a table 220 may have the proximity sensors 220A installed beneath it, and may be associated with a plurality of chairs 230 equipped with weight sensors 220B. The proximity sensors 220A and the weight sensors 220B may work collectively to identify diners being seated.

The reason that both the proximity sensors 220A and the weight sensors 220B are necessary is that, using one type sensor may result in false positive determinations. For example, it is possible that someone may get close to the table 220 but not take a seat (e.g., an employee cleaning the table, a customer who comes back to collect his belongings left on the table). In this case, if only proximity sensors 220A are used, the person may be detected and wrongfully registered in the computing system. As another example, it is also possible that a customer may place his bags or other belongings on an empty chair. In this case, if only weight sensors 220B are used, the chair may wrongfully register a diner in the computing system. When both the proximity sensors 220A and the weight sensors 220B are being used, such false positives may be avoided.

In some embodiments, a proximity sensor 220A may first detect a person close to the table, and a weight sensor 220B may then detect the person taking a seat at the table. The timestamps of these two detections may not be exactly the same, but as long as they are within a predetermined threshold (e.g., 5 seconds), it may be determined that a person just took a seat at the table.

In some embodiments, other types of sensors may be installed, such as motion sensors detecting objects moving towards a table or a chair, image sensors identifying dinners (e.g., through facial recognition) taking seats at a table, other suitable sensors, or any combination thereof.

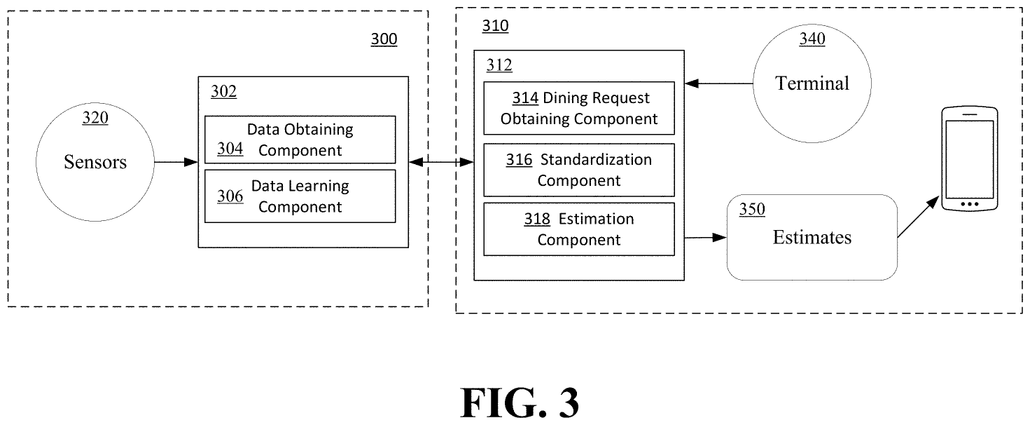

FIG. 3 illustrates an example system for optimizing waiting time, in accordance with some embodiments. The example system in FIG. 3 may comprise two subsystems: an offline subsystem 300 and an online subsystem 310. The offline subsystem 300 may comprise a computing system 302 that trains a machine learning model based on historical data. In some embodiments, the machine learning model may be a classifier. The online subsystem 310 may comprise a computing system 312 to provide real-time estimations of waiting times for dining parties.

In some embodiments, the computing system 302 in the offline subsystem 300 may comprise a data obtaining component 304, and a data learning component 306. The components listed in FIG. 3 are illustrative, the computing system 302 may comprise additional, fewer, or alternative components according to different embodiments.

In some embodiments, the data obtaining component 304 may collect data from various sensors 320 installed on the tables (e.g., proximity sensors) and the chairs (e.g., weight sensors). These data may be used to extract dining information of the dining parties. In some embodiments, the dining information of a dining party may comprise a starting time, an ending time, a dining duration, a party size. The starting time may be determined as the earliest point in time when a person of the dining party is detected by both a proximity sensor on a table and a weight sensor on a chair associated with the table. The details of using sensors to detect a diner are described in FIG. 2. The ending time may be determined as the last point in time when a person of the dining party is detected leaving the table (and leaving the chair) by a proximity sensor on the table and a weight sensor on a chair associated with the table.

In some embodiments, the dining duration of a dining party may be determined as the difference between the starting time and ending time detected by the sensors. In some embodiments, the party size may be determined as the maximum number of diners detected by the sensors between the starting time and the ending time. It may be appreciated that the party size may be referred to as the actual party size, which may be different from the requested party size (e.g., the party size registered when the party signs up a dining request).

In some embodiments, the data obtaining component 304 may collect sufficient historical data to form a training data set. The data learning component 306 may use such training data to train a machine learning model to estimate a dining duration for a piece of given party information. Each data entry in the training data set may be the dining information of a dining party. Each data entry comprises a plurality of features and one or more labels. For example, the features may comprise the party size, the starting time (e.g., which month of the year, which day of the week, and what time of the day), the number of children in the dining party, identifiers associated with specific diners (e.g., obtained by facial recognition, or obtained from the profile information of the specific diners), another suitable feature, or any combination thereof. As another example, each of the data entries (e.g., dining information) may be labeled by the corresponding dining duration. Such training data may be used by a supervised machine learning algorithm to train a classifier. The classifier may be able to make predictions (e.g., estimated dining durations) based on input data comprising the above-mentioned features of dining parties.

The trained classifier may be utilized by the online subsystem 310 to make real-time waiting time estimation. In some embodiments, the computing system 312 in the online subsystem 310 may comprise one or more components, such as a dining request obtaining component 314, a standardization component 316, and an estimation component 318. Depending on the embodiments, the computing system 312 may comprise additional, fewer, or alternative components.

The dining request obtaining component 312 may obtain a list of dining requests through a terminal 340 associated with the restaurant. In some embodiments, the terminal 340 may be a computer system placed at the reception area of the restaurant for the dining parties on the premises to input their dining requests. In some embodiments, the terminal 340 may be an online-portal (such as a web page, an application on mobile devices) where the dining parties may input their dining requests when they are within a predetermined distance to the restaurant. For example, the application on one diner's mobile device may monitor the real-time location of the diner (e.g., the diner's mobile device), and if the real-time location is within 0.5 or 1 mile from the restaurant's location, the application may allow the diner to make dining requests. The close distance requirement may effectively increase the certainty that the dinners will show up in the restaurant to fulfill their dining requests.

When a dining party inputs a dining request through the terminal 340, it may provide information such as a requested dining party size, a number of children in the party, a phone number, and other suitable information. The phone number may be used for multiple purposes, such as for communication purposes (e.g., receiving notifications from the computing system of the restaurant), and/or for the purpose of identifying the diner (e.g., the phone number may be associated with the diner and may be used to retrieve the diner's profile). In some embodiments, the terminal may accept other forms of personally identifiable information such as fingerprint, a customer number, or facial recognition in lieu of the phone numbers. The personally identifiable information may be used to retrieve the dinners' contact information and historical dining information.

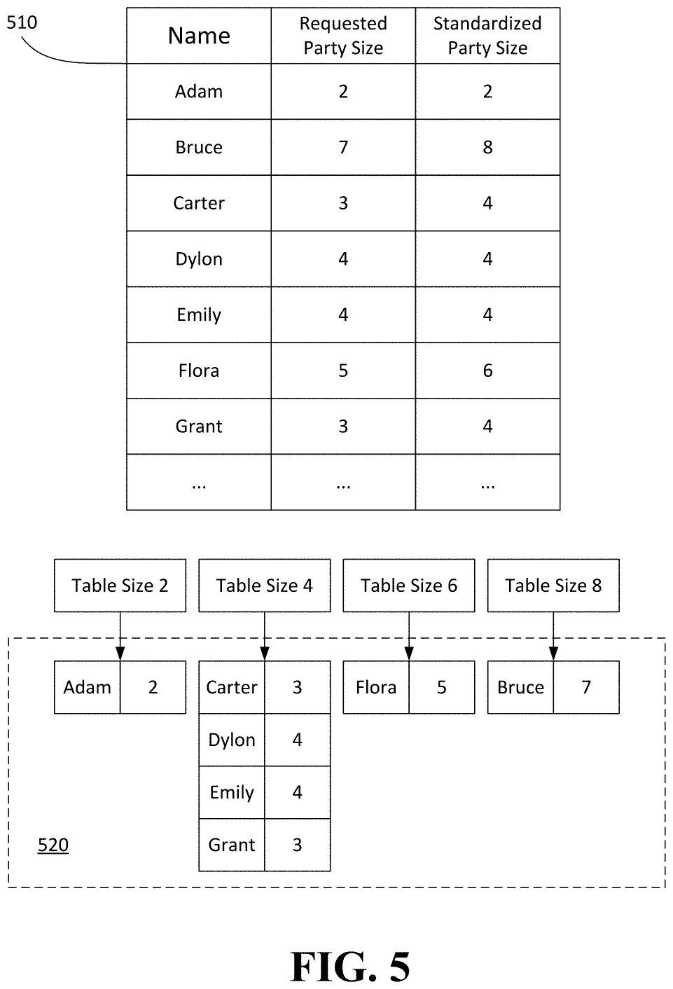

In some embodiments, the standardization component 316 may standardize some portion of the dining information of the list of dining requests obtained by the dining request obtaining component 312. Oftentimes a restaurant may have tables of various serving capacities (e.g. table sizes), such as tables serving 1-2 dinners, and tables serving 6-8 dinners. The waiting time estimation for parties of 1-2 dinners may be independent from the waiting time estimation for parties of 6-8 dinners. As a result, the list of dining requests may be divided into sublists, and the parties that may be served by tables of the same serving capacity should be grouped together. However, the dining information provided by the dining parties may only comprise the requested party sizes, which may not be directly used for grouping. The standardization component 316 may convert the requested party sizes to standardized party sizes by considering the available table serving capacities in the restaurant. The parties that can be served by tables of the same serving capacity may have the same standardized party size, and thus be grouped together for waiting time estimation purpose. The details of the standardization process may refer to FIG. 5.

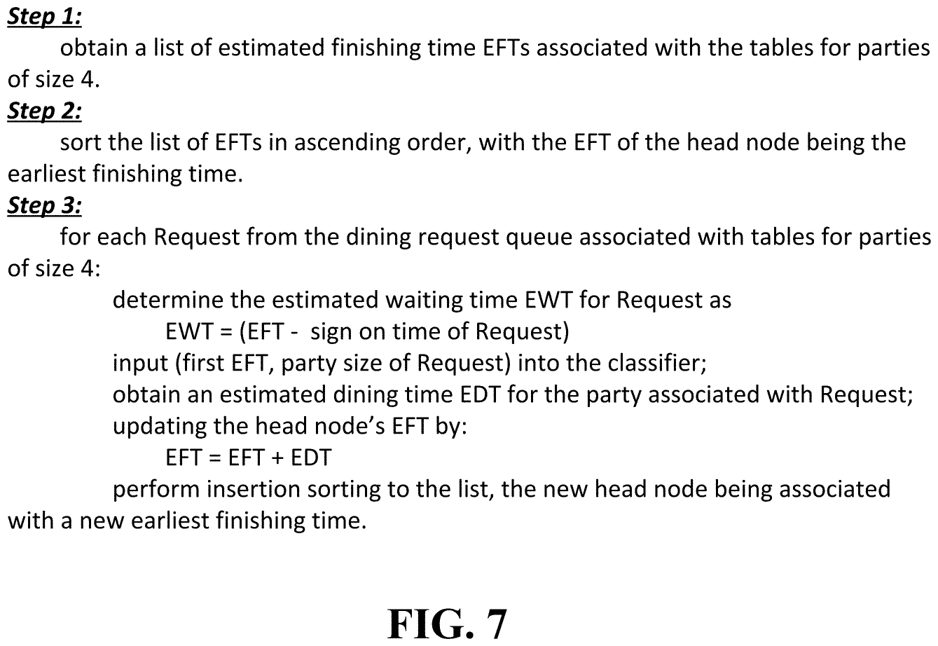

In some embodiments, after the dining parties (e.g., the dining requests) being grouped, the estimation component 318 may provide estimated waiting times for the dining parties in the sublists. Since there is no dependence between the sublists, the estimation task for each sublist may be carried out independently from others. That is, the sublists may be processed by the estimation component 318 in parallel. The details of making waiting time estimations for the parties in each sublist may refer to FIG. 7. In some embodiments, the estimates 350 generated by the estimation component 318 may be delivered to the dining parties through mobile devices (e.g., by SMS, or in-app notifications).

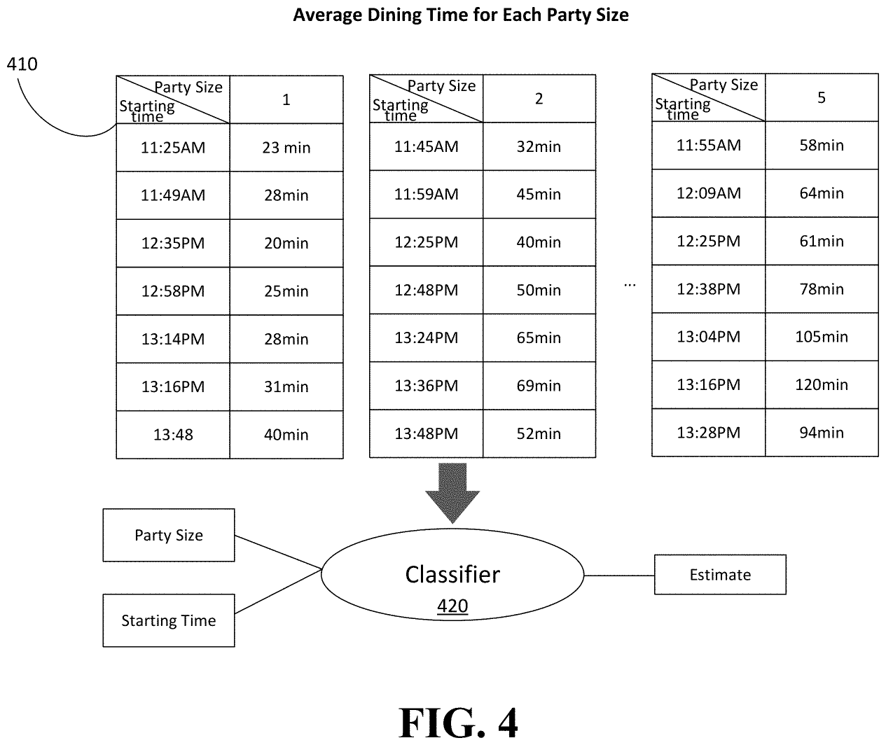

FIG. 4 illustrates an example diagram for training a classifier, in accordance with some embodiments. In order to obtain a classifier or another suitable machine learning model to predict dining durations based on various inputs, sufficient training data needs to be collected. In some embodiments, dining information of dining parties collected by the above mentioned sensors (e.g., proximity sensors and weight sensors) may be collected to form the training data. Each data entry in the training data may correspond to one ding party's dining information, which may comprise starting time (e.g., accurate to a minute level, or a time including the month of the year, the day of the week, the minute of the day), actual party size (e.g., detected by the sensors, not the estimated party size when making the dining request), number of children, personal identifiable information, dining duration measured by the sensors, other suitable information, or any combination thereof. Some features of the data entries may be treated as features and other features of the data entries may be noted as labels (e.g., dining duration).

For the sake of simplicity, the example shown in FIG. 4 simplifies the training data by only using two features and one label (e.g., dining duration that is accurate to the minute level). The two features include party size, and starting time, where the starting time is accurate to the minute level. The one label is a dining duration. The table 410 in FIG. 4 shows examples of the collected dining information. In some embodiments, in addition to the time of the day, the starting time in each data entry (e.g., dining information) may also include the date information. In some embodiments, the dining duration may include the actual dining duration measured by the sensors installed on the tables and chairs, and a predetermined duration for the employees to clean up and set up the table (e.g., 3 minutes).

The relationship between the features (e.g., the party size and the starting time) and the label (e.g., the dining duration) may be implicit and may have too many factors to be represented with a simple mathematical equation. This is where machine learning algorithms may be helpful to learn the implicit relationship. Since the data entries in the training data may all have labels, supervised machine learning algorithms may be adopted to train the classifier 420. There is no limitation on the type of machine learning algorithm in this specification, neural networks, decision trees, or other suitable machine learning algorithms may be used to train the classifier.

As shown in FIG. 4, the trained classifier 420 may generate an estimated dining duration based on the input features such as party size and starting time. The classifier 420 may be used by the online subsystem 310 in FIG. 3 to estimate waiting times for the waiting dining parties.

FIG. 5 illustrates an example diagram for standardizing and grouping dining requests, in accordance with some embodiments. When a dining party makes a dining request (e.g., making a reservation), it may provide various information including a requested party size, a name of the person of contact, a phone number, and other suitable information (e.g., a number of children, ages of the children, a member identifier associated with a diner's profile and historical information). As explained in FIG. 3, these requested party sizes may be standardized first, so that the dining parties may be divided into sublists based on the standardized party sizes. The waiting time estimation process may be performed in parallel among the sublists.

For simplicity, the table 510 in FIG. 5 only shows the names of the parties (e.g., the names of the persons of contact), and the requested party sizes. In some embodiments, the requested party sizes may be standardized in the following way: identifying, by the computing device from the available table sizes in the restaurant, a smallest table size that is equal to or greater than the each waiting party size; and determining the smallest table size as the standardized party size. For example, if the restaurant in question has a first type of tables to serve 1-2 diners, a second type of tables to serve 3-4 diners, a third type of tables to serve 5-6 diners, and a fourth type of tables to serve 7-8 diners, a party with a requested party size 7 may be standardized as 8, and a party with a requested party size 3 may be standardized as 4. The table 510 in FIG. 5 shows the standardization results of the requested party sizes.

After the requested party sizes are standardized, the parties may be divided into sublists. Each sublist may comprise the parties with the same standardized part size. As shown in FIG. 5, there are four parties (e.g., party Carter with 3 diners, party Dylan with 4 diners, party Emily with 4 diners, and party Grant with 3 diners) are in the same sublist which may be served by tables that can serve 3-4 diners.

In some embodiments, there may be overlaps between the servicing capacities of the tables. That is, one party may be served by multiple types of tables. For instance, a restaurant may have a first type of tables to serve 1-2 diners, and a second type of tables to serve 2-4 diners. As a result, a party of 2 diners may be served by either the first type of tables and the second types of tables. In this case, the party of 2 may exist in both sublists corresponding to the first type of table and the second type of table. Using the case in FIG. 5 as an example, the Adam party of 2 may be in the “Table Size 2” sublist as well as the “Table Size 4” sublist.

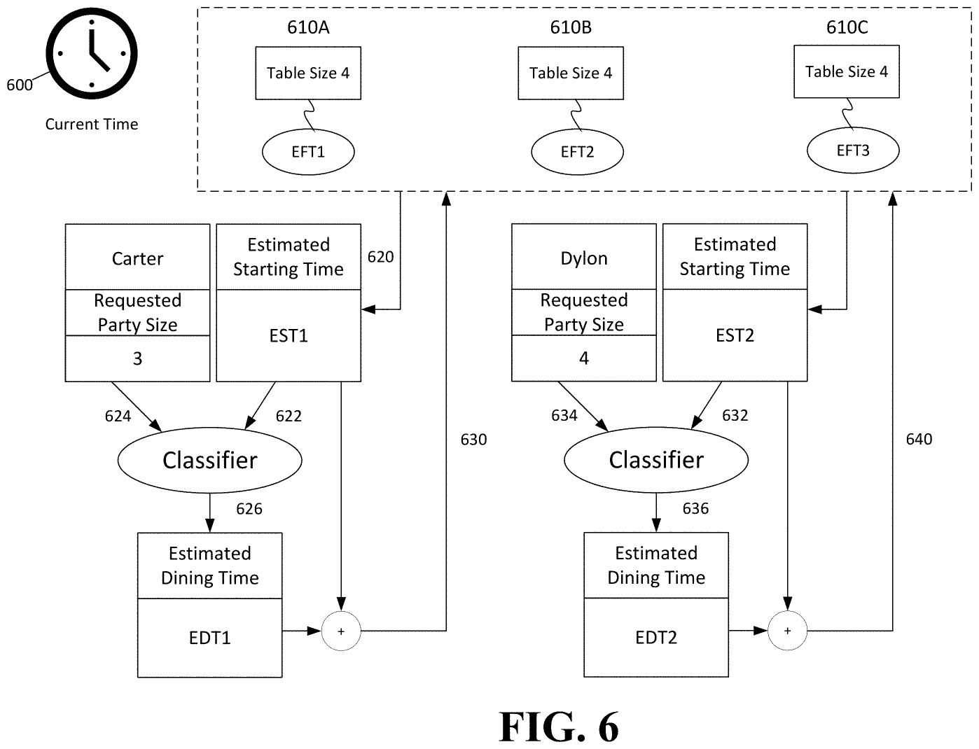

FIG. 6 illustrates an example flow for optimizing waiting time estimation, in accordance with some embodiments. The example flow in FIG. 6 continues to use the same example of FIG. 5. In particular, the example flow in FIG. 6 uses the “Table Size 4” sublist of FIG. 5 to explain an embodiment of the method for optimizing waiting time estimations.

As shown in FIG. 6, the hypothetical restaurant has three tables to serve the parties in the “Table Size 4” sublist, table 610A, table 610B, and table 610C. If one of these tables is empty, the next available dining party may be immediately seated. That is, assuming there are N available tables with a serving capacity of 4, the first N dining parties' waiting times are presumed as 0. After these tables are occupied, each table may be associated with an estimated finishing time (EFT). These EFTs may be obtained by using the classifier (described in FIGS. 3 and 4) based on the dining information detected by the sensors installed on the table and the associated chairs. For example, as shown in FIG. 6, tables 610A, 610B, and 610C are respectively associated with EFT1, EFT2, and EFT3. It may be appreciated that the classifier may only generate estimated dining durations, which may need to be converted to EFT by adding the dining durations to the current time 600.

For each of the subsequent (e.g., waiting) dining parties, the computing system of the restaurant may generate an estimated waiting time. An estimated waiting time may be determined based on an estimated starting time (EST) and the current time 600 (e.g., the difference between an EST and the current time may be the estimated waiting time). Referring back to the example in FIG. 6, for the first waiting party Carter, its estimated starting time EST1 may be determined as the smallest of EFT1, EFT2, and EFT3 at step 620. Then, the EST1 may be input into the classifier as one input feature at step 622, and the requested party size of the party Carter (e.g., 3) may be input into the classifier as another input feature at step 624. In some embodiments, other features such as number of children, personal identifier associated with a profile or historical data may also be input into the classifier (e.g., if the classifier is trained with these features). The classifier may subsequently generate an estimated dining time EDT1 at step 626 for the party Carter. This EDT1 may be added to the EST1 to obtain the estimated finishing time for the party Carter. This estimated finishing time may then be used to update the smallest of EFT1, EFT2 and EFT3 at step 630. For example, if EFT1 (corresponding to table 610A) is smaller than both EFT2 and EFT3, it means the party Carter will be assigned to the table 610A. The estimated finishing time of the party Carter may then be added to EFT1 to obtain a new EFT1′ representing “assuming the party Carter uses table 610A, what is the finishing time.”

For the next party Dylan, the estimated starting time EST2 may be determined as the smallest of the updated EFT1, EFT2, and EFT3 (e.g., the EFT1 now becomes EFT1′). Similarly, the EST2 may be input to the classifier as one input feature at step 632, and the corresponding requested party size (e.g., 4) may be input to the classifier as another input feature at step 634. In response, the classifier may generate an estimated dining time EDT2 for the party Dylan at step 636. This estimated dining time may then be added to the EST2 to update the smallest of EFT1′, EFT2, and EFT3 at step 640. Assuming that EFT2 (corresponding to table 610B) is the smallest (e.g., EFT2 is smaller than EFT1′ and EFT3), it means the party Dylan will be assigned to table 610B. Thus, the EFT2 may be updated to EFT2′. This process may continue until all the parties in the same sublist receive estimated waiting times. In some embodiments, the estimated starting times for the parties may be sent to the mobile devices associated with the parties. In other embodiments, the estimated starting times may be converted to estimated waiting times (e.g., an estimated starting time minus the current time is the estimated waiting time) before sending to the mobile devices.

In some embodiments, as mentioned in FIG. 5, one party may be grouped into multiple sublists and may receive multiple estimated waiting times. In this case, the smallest estimated waiting time may be selected and sent to the mobile device associated with the party. Furthermore, the sublists corresponding to the larger estimated waiting times may be updated by removing the party. In particular, in these sublists, the waiting parties ranked after the removed party may receive updated estimated waiting times.

In some embodiments, during the course of dining, the party size may change dynamically (e.g., a new diner joins, a diner leaves). These changes may affect the estimated finishing time, which may affect some of the waiting parties' waiting time. In this case, the computing system of the restaurant may update the estimated waiting times based on up-to-date dining information. In some embodiments, when the difference between an updated estimated waiting time and an original estimated waiting time is greater than a predetermined threshold, a notification may be sent to the mobile device associated with the affected party.

FIG. 7 illustrates an example method for optimizing waiting time estimation, in accordance with some embodiments. Depending on the implementation, the method may comprise additional, fewer, or alternative steps. The method in FIG. 7 continues to use the example in FIG. 6, where the parties to receive estimated waiting times are in the same sublist corresponding to tables serving 4 diners. The method may comprise multiple steps.

In Step 1, obtain a list of estimated finishing time EFTs associated with the tables for parties of size 4.

In Step 2, sort the list of EFTs in ascending order, with the EFT of the head node being the earliest finishing time.

In step 3, for each Request from the dining request queue associated with tables for parties of size 4: determine the estimated waiting time EWT for Request as EWT=(EFT−sign on time of Request); input (first EFT, party size of Request) into the classifier; obtain an estimated dining time EDT for the party associated with Request; updating the head node's EFT by EFT=EFT+EDT; and perform insertion sorting to the list, the new head node being associated with a new earliest finishing time.

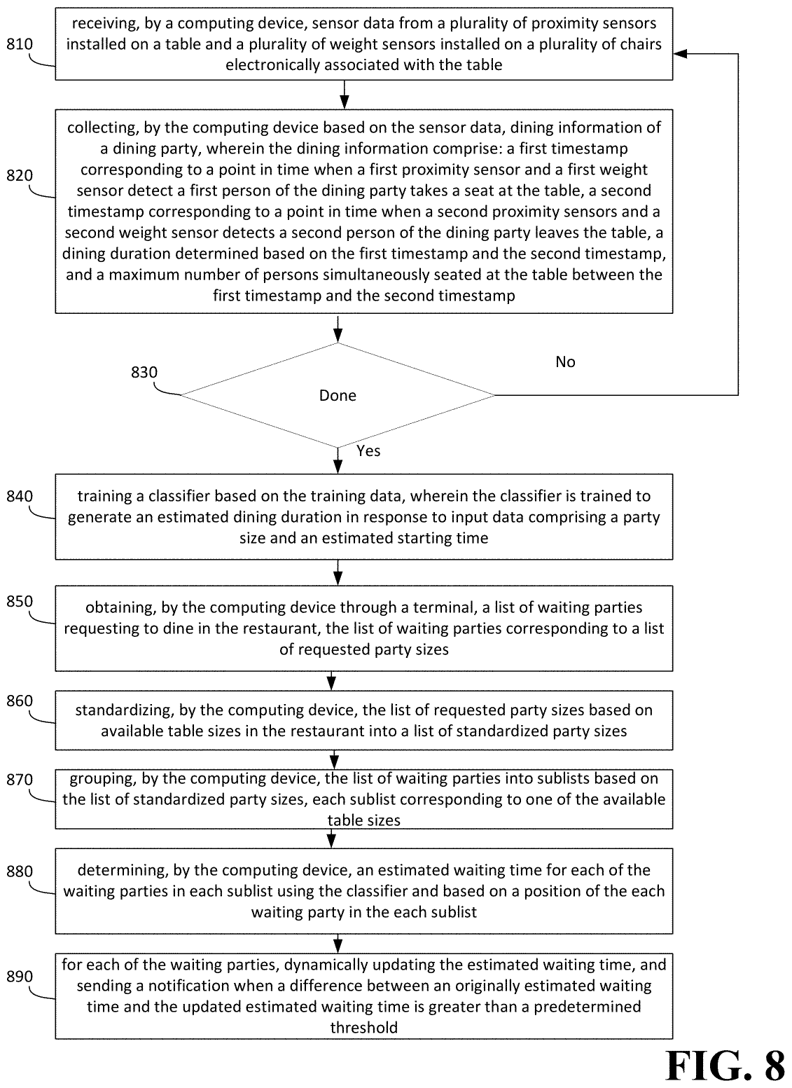

FIG. 8 illustrates another example method for optimizing waiting time estimation, in accordance with some embodiments. The method in FIG. 8 may be implemented by the devices and systems shown in FIGS. 1-6.

In Block 801, the method comprises: receiving, by a computing device, sensor data from a plurality of proximity sensors installed on a table and a plurality of weight sensors installed on a plurality of chairs electronically associated with the table.

In Block 802, the method comprises: collecting, by the computing device based on the sensor data, dining information of a dining party, wherein the dining information comprise: a first timestamp corresponding to a point in time when a first proximity sensor and a first weight sensor detect a first person of the dining party takes a seat at the table, a second timestamp corresponding to a point in time when a second proximity sensors and a second weight sensor detects a second person of the dining party leaves the table, a dining duration determined based on the first timestamp and the second timestamp, and a maximum number of persons simultaneously seated at the table between the first timestamp and the second timestamp. In some embodiments, the first proximity sensor and the first weight sensor detect a first person of the dining party takes a seat at the table when: the first proximity sensor detects an object within a preset range at a first point in time; the first weight sensor detects an object at a second point in time; and a difference between the first point in time and the second point in time is less than a predetermined value. In some embodiments, the dining duration is a summation of a difference between the first timestamp and the second timestamp, and a predetermined duration corresponding to a period for clearing and setting up a table.

In Block 803, the method comprises a determination whether the repeating process (steps shown in Block 801 and Block 802) should be terminated.

In Block 804, the method comprises: training a classifier based on the training data, wherein the classifier is trained to generate an estimated dining duration in response to input data comprising a party size and an estimated starting time.

In Block 805, the method comprises: obtaining, by the computing device through a terminal, a list of waiting parties requesting to dine in the restaurant, the list of waiting parties corresponding to a list of requested party sizes.

In Block 806, the method comprises: standardizing, by the computing device, the list of requested party sizes based on available table sizes in the restaurant into a list of standardized party sizes. In some embodiments, standardizing, by the computing device, the list of requested party sizes based on the available table sizes in the restaurant into the list of standardized party sizes comprises: for each of the requested party sizes: identifying, by the computing device from the available table sizes in the restaurant, a smallest table size that is equal to or greater than the each waiting party size; and determining the smallest table size as the standardized party size.

In Block 807, the method comprises: grouping, by the computing device, the list of waiting parties into sublists based on the list of standardized party sizes, each sublist corresponding to one of the available table sizes.

In Block 808, the method comprises: determining, by the computing device, an estimated waiting time for each of the waiting parties in each sublist using the classifier and based on a position of the each waiting party in the each sublist. In some embodiments, the sublists are independent from each other, and the determining an estimated waiting time for each of the waiting parties in each sublist is performed in parallel among the sublists. In some embodiments, if the restaurant has N tables with a table size of S, the determining an estimated waiting time for each of the waiting parties in each sublist comprises: for an i-th waiting party in the each sublist corresponding to the table size S: in response to i<=N, determining the estimated waiting time for the i-th waiting party as 0, associating a table serving the i-th waiting party with an estimated finishing time, wherein the estimated finishing time is determined using the classifier based on the requested party size of the i-th waiting party and the first timestamp associated with the i- th waiting party, and updating the estimated finishing time if a number of persons detected by the proximity sensors and the weight sensors associated with the table becomes different from the requested party size of the i-th waiting party, wherein the updated estimated finishing time is determined using the classifier based on the number of persons detected; and in response to i>N, determining the waiting time for the i-th waiting party as a difference between a smallest estimated finishing time among N estimated finishing times and the current time, determining an estimated starting time for the i-th waiting party that equals to the smallest estimated finishing time among the N estimated finishing times, and updating the smallest estimated finishing time among the N estimated finishing times by adding the estimated duration for the i-th waiting party that is determined using the classifier based on the i-th waiting party size of the i-th waiting party and the estimated starting time for the i-th waiting party.

In Block 808, the method comprises: for each of the waiting parties, dynamically updating the estimated waiting time, and sending a notification when a difference between an originally estimated waiting time and the updated estimated waiting time is greater than a predetermined threshold.

In some embodiments, the method further comprises: periodically sending the updated estimated waiting time to a mobile device associated with the each waiting party as a remaining waiting time.

In some embodiments, in response to one of the waiting parties is grouped into more than one sublist, the method further comprises: determining the estimated waiting time for the one waiting party in each of the more than one sublist; identifying a first sublist from the more than one sublist that provides a smallest estimated waiting time for the one waiting party; determining the smallest estimated waiting time as the estimated waiting time for the one waiting party; removing the one waiting party from the more than one sublist excluding the first sublist; and updating the estimated waiting times for the waiting parties that are in the more than one sublist excluding the first sublist and that are originally after the removed one waiting party.

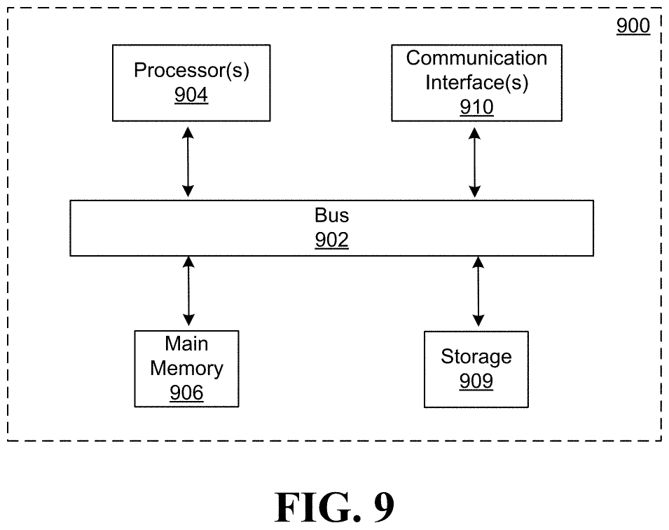

FIG. 9 illustrates an example electronic device for optimizing resource allocation. The electronic device may be used to implement one or more components of the systems, workflow, methods shown in FIG. 1-6. The electronic device 900 may comprise a bus 902 or other communication mechanism for communicating information and one or more hardware processors 904 coupled with bus 902 for processing information. Hardware processor(s) 904 may be, for example, one or more general purpose microprocessors.

The electronic device 900 may also include a main memory 906, such as a random-access memory (RAM), cache and/or other dynamic storage devices, coupled to bus 902 for storing information and instructions to be executed by processor(s) 904. Main memory 906 also may be used for storing temporary variables or other intermediate information during execution of instructions to be executed by processor(s) 904. Such instructions, when stored in storage media accessible to processor(s) 904, may render electronic device 900 into a special-purpose machine that is customized to perform the operations specified in the instructions. Main memory 906 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The electronic device 900 may implement the techniques described herein using customized hard-wired logic, one or more ASICs or FPGAs, firmware and/or program logic which in combination with the electronic device may cause or program electronic device 900 to be a special-purpose machine. According to one embodiment, the techniques herein are performed by electronic device 900 in response to processor(s) 904 executing one or more sequences of one or more instructions contained in main memory 906. Such instructions may be read into main memory 906 from another storage medium, such as storage device 909. Execution of the sequences of instructions contained in main memory 906 may cause processor(s) 904 to perform the process steps described herein. For example, the processes/methods disclosed herein may be implemented by computer program instructions stored in main memory 906. When these instructions are executed by processor(s) 904, they may perform the steps as shown in corresponding figures and described above. In alternative embodiments, hard-wired circuitry may be used in place of or in combination with software instructions.

The electronic device 900 also includes a communication interface 910 coupled to bus 902. Communication interface 910 may provide a two-way data communication coupling to one or more network links that are connected to one or more networks. As another example, communication interface 910 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed sequentially, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for determining waiting times in a restaurant, comprising:
collecting training data by repeating following steps for a predetermined number of times:
receiving, by a computing device, sensor data from a plurality of proximity sensors installed on a table and a plurality of weight sensors installed on a plurality of chairs electronically associated with the table;
collecting, by the computing device based on the sensor data, dining information of a dining party, wherein the dining information comprise:
a first timestamp corresponding to a point in time when a first proximity sensor and a first weight sensor detect a first person of the dining party takes a seat at the table,
a second timestamp corresponding to a point in time when a second proximity sensors and a second weight sensor detects a second person of the dining party leaves the table,
a dining duration determined based on the first timestamp and the second timestamp, and
a maximum number of persons simultaneously seated at the table between the first timestamp and the second timestamp; and
training a classifier based on the training data, wherein the classifier is trained to generate an estimated dining duration in response to input data comprising a party size and an estimated starting time;
obtaining, by the computing device through a terminal, a list of waiting parties requesting to dine in the restaurant, the list of waiting parties corresponding to a list of requested party sizes;
standardizing, by the computing device, the list of requested party sizes based on available table sizes in the restaurant into a list of standardized party sizes;
grouping, by the computing device, the list of waiting parties into sublists based on the list of standardized party sizes, each sublist corresponding to one of the available table sizes;
determining, by the computing device, an estimated waiting time for each of the waiting parties in each sublist using the classifier and based on a position of the each waiting party in the each sublist; and
for each of the waiting parties, dynamically updating the estimated waiting time, and sending a notification when a difference between an originally estimated waiting time and the updated estimated waiting time is greater than a predetermined threshold.

2. The method of claim 1, wherein the first proximity sensor and the first weight sensor detect a first person of the dining party takes a seat at the table when:
the first proximity sensor detects an object within a preset range at a first point in time;
the first weight sensor detects an object at a second point in time; and
a difference between the first point in time and the second point in time is less than a predetermined value.

3. The method of claim 1, wherein the dining duration is a summation of a difference between the first timestamp and the second timestamp, and a predetermined duration corresponding to a period for clearing and setting up a table.

4. The method of claim 1, wherein standardizing, by the computing device, the list of requested party sizes based on the available table sizes in the restaurant into the list of standardized party sizes comprises:
for each of the requested party sizes:
identifying, by the computing device from the available table sizes in the restaurant, a smallest table size that is equal to or greater than the each waiting party size; and
determining the smallest table size as the standardized party size.

5. The method of claim 1, wherein the sublists are independent from each other, and the determining an estimated waiting time for each of the waiting parties in each sublist is performed in parallel among the sublists.

6. The method of claim 1, wherein
the restaurant has N tables with a table size of S, and
the determining an estimated waiting time for each of the waiting parties in each sublist comprises:
for an i-th waiting party in the each sublist corresponding to the table size S:
in response to i<=N,
determining the estimated waiting time for the i-th waiting party as 0,
associating a table serving the i-th waiting party with an estimated finishing time, wherein the estimated finishing time is determined using the classifier based on the requested party size of the i-th waiting party and the first timestamp associated with the i-th waiting party, and
updating the estimated finishing time if a number of persons detected by the proximity sensors and the weight sensors associated with the table becomes different from the requested party size of the i-th waiting party, wherein the updated estimated finishing time is determined using the classifier based on the number of persons detected; and
in response to i>N,
determining the waiting time for the i-th waiting party as a difference between a smallest estimated finishing time among N estimated finishing times and the current time,
determining an estimated starting time for the i-th waiting party that equals to the smallest estimated finishing time among the N estimated finishing times, and
updating the smallest estimated finishing time among the N estimated finishing times by adding the estimated duration for the i-th waiting party that is determined using the classifier based on the i-th waiting party size of the i-th waiting party and the estimated starting time for the i-th waiting party.

7. The method of claim 1, further comprising:
periodically sending the updated estimated waiting time to a mobile device associated with the each waiting party as a remaining waiting time.

8. The method of claim 1, wherein in response to one of the waiting parties is grouped into more than one sublist, the method further comprises:
determining the estimated waiting time for the one waiting party in each of the more than one sublist;
identifying a first sublist from the more than one sublist that provides a smallest estimated waiting time for the one waiting party;
determining the smallest estimated waiting time as the estimated waiting time for the one waiting party;
removing the one waiting party from the more than one sublist excluding the first sublist; and
updating the estimated waiting times for the waiting parties that are in the more than one sublist excluding the first sublist and that are originally after the removed one waiting party.

9. A system for determining waiting times in a restaurant, comprising one or more processors and one or more non-transitory computer-readable memories coupled to the one or more processors and configured with instructions executable by the one or more processors to cause the system to perform operations comprising:
collecting training data by repeating following steps for a predetermined number of times:
receiving sensor data from a plurality of proximity sensors installed on a table and a plurality of weight sensors installed on a plurality of chairs electronically associated with the table;
collecting, based on the sensor data, dining information of a dining party, wherein the dining information comprise:
a first timestamp corresponding to a point in time when a first proximity sensor and a first weight sensor detect a first person of the dining party takes a seat at the table,
a second timestamp corresponding to a point in time when a second proximity sensors and a second weight sensor detects a second person of the dining party leaves the table,
a dining duration determined based on the first timestamp and the second timestamp, and
a maximum number of persons simultaneously seated at the table between the first timestamp and the second timestamp; and
training a classifier based on the training data, wherein the classifier is trained to generate an estimated dining duration in response to input data comprising a party size and an estimated starting time;
obtaining, through a terminal, a list of waiting parties requesting to dine in the restaurant, the list of waiting parties corresponding to a list of requested party sizes;
standardizing the list of requested party sizes based on available table sizes in the restaurant into a list of standardized party sizes;
grouping the list of waiting parties into sublists based on the list of standardized party sizes, each sublist corresponding to one of the available table sizes;
determining an estimated waiting time for each of the waiting parties in each sublist using the classifier and based on a position of the each waiting party in the each sublist; and
for each of the waiting parties, dynamically updating the estimated waiting time, and sending a notification when a difference between an originally estimated waiting time and the updated estimated waiting time is greater than a predetermined threshold.

10. The system of claim 9, wherein the first proximity sensor and the first weight sensor detect a first person of the dining party takes a seat at the table when:
the first proximity sensor detects an object within a preset range at a first point in time;
the first weight sensor detects an object at a second point in time; and
a difference between the first point in time and the second point in time is less than a predetermined value.

11. The system of claim 9, wherein the dining duration is a summation of a difference between the first timestamp and the second timestamp, and a predetermined duration corresponding to a period for clearing and setting up a table.

12. The system of claim 9, wherein standardizing the list of requested party sizes based on the available table sizes in the restaurant into the list of standardized party sizes comprises:
for each of the requested party sizes:
identifying, from the available table sizes in the restaurant, a smallest table size that is equal to or greater than the each waiting party size; and
determining the smallest table size as the standardized party size.

13. The system of claim 9, wherein the sublists are independent from each other, and the determining an estimated waiting time for each of the waiting parties in each sublist is performed in parallel among the sublists.

14. The system of claim 9, wherein the restaurant has N tables with a table size of S, and the determining an estimated waiting time for each of the waiting parties in each sublist comprises:
for an i-th waiting party in the each sublist corresponding to the table size S:
in response to i<=N,
determining the estimated waiting time for the i-th waiting party as 0,
associating a table serving the i-th waiting party with an estimated finishing time, wherein the estimated finishing time is determined using the classifier based on the requested party size of the i-th waiting party and the first timestamp associated with the i-th waiting party, and
updating the estimated finishing time if a number of persons detected by the proximity sensors and the weight sensors associated with the table becomes different from the requested party size of the i-th waiting party, wherein the updated estimated finishing time is determined using the classifier based on the number of persons detected; and
in response to i>N,
determining the waiting time for the i-th waiting party as a difference between a smallest estimated finishing time among N estimated finishing times and the current time,
determining an estimated starting time for the i-th waiting party that equals to the smallest estimated finishing time among the N estimated finishing times, and
updating the smallest estimated finishing time among the N estimated finishing times by adding the estimated duration for the i-th waiting party that is determined using the classifier based on the i-th waiting party size of the i-th waiting party and the estimated starting time for the i-th waiting party.

15. The system of claim 9, the operations further comprise:
periodically sending the updated estimated waiting time to a mobile device associated with the each waiting party as a remaining waiting time.

16. The system of claim 9, in response to one of the waiting parties is grouped into more than one sublist, the operations further comprise:
determining the estimated waiting time for the one waiting party in each of the more than one sublist;
identifying a first sublist from the more than one sublist that provides a smallest estimated waiting time for the one waiting party;
determining the smallest estimated waiting time as the estimated waiting time for the one waiting party;
removing the one waiting party from the more than one sublist excluding the first sublist; and
updating the estimated waiting times for the waiting parties that are in the more than one sublist excluding the first sublist and that are originally after the removed one waiting party.
